(19) United States
(12) Patent Application Publication
(10) Pub. No.: US 2012/0304018 A1
(43) Pub. Date: Nov. 29, 2012

(54) APPARATUS FOR TESTING BASIC INPUT OUTPUT SYSTEM CHIP

(75) Inventors: JIAN-CHUN PAN, Shenzhen City (CN); HAI-QING ZHOU, Shenzhen City (CN); YI-XIN TU, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD., Shenzhen City (CN)

(21) Appl. No.: 13/278,122

(22) Filed: Oct. 20, 2011

(30) Foreign Application Priority Data
May 26, 2011 (CN) 201110138531.3

(51) Int. Cl. G06F 11/273

(52) U.S. Cl. 714/45; 714/E11.17

(57) ABSTRACT

An apparatus for testing a basic input output system (BIOS) chip includes a base and a connector. The base defines a receiving space for housing the BIOS chip. A number of signal pins are formed on sidewalls bounding the receiving space, to electrically connect the BIOS chip. The connector extends from a bottom of the base, and is electrically connected to the signal pins of the base to be connected to a diagnose card to debug the BIOS chip.

### BACKGROUND

1. Technical Field

The present disclosure relates to an apparatus for testing a basic input output system (BIOS) chip.

2. Description of Related Art

Manufacturers may use a diagnostic card to debug a BIOS chip of a device by inserting the card into a special connector set on a motherboard of the device and reserved for that purpose, which takes up precious space of the motherboard. Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an isometric view of an apparatus in accordance with an embodiment of the present disclosure, together with a basic input output system (BIOS) chip arranged on a motherboard, wherein the apparatus includes a connector.

FIG. 2 is a diagram showing pin distribution of the connector of FIG. 1.

FIG. 3 is an inverted view of the apparatus of FIG. 1.

### DETAILED DESCRFIPTION

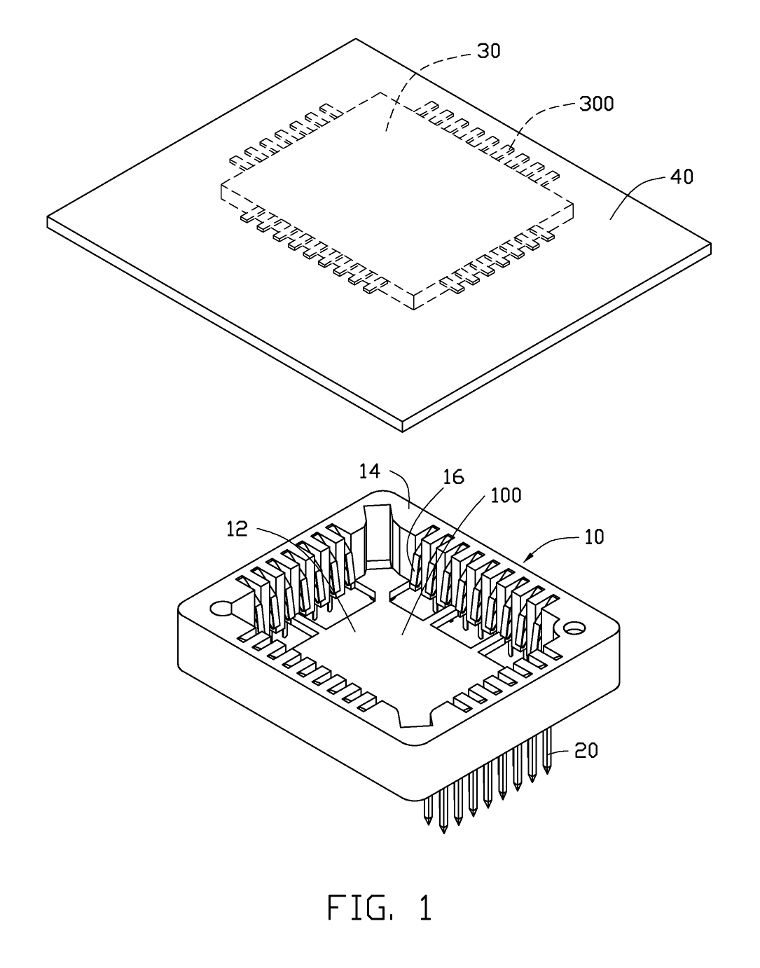

Referring to FIG. 1, an embodiment of an apparatus for testing a basic input output system (BIOS) chip 30 mounted on a motherboard 40 includes a base 10 and a connector 20.

The base 10 includes a plate 12 and four sidewalls 14 perpendicularly extending up from sides of the plate 12. The plate 12 and the sidewalls 14 bound a receiving space 100 to house the BIOS chip 30. A plurality of signal pins 16 is mounted on each sidewall 14. When the BIOS chip 30 is inserted into the receiving space 100, the signal pins 16 are electrically connected to the pins 300 of the BIOS chip 30.

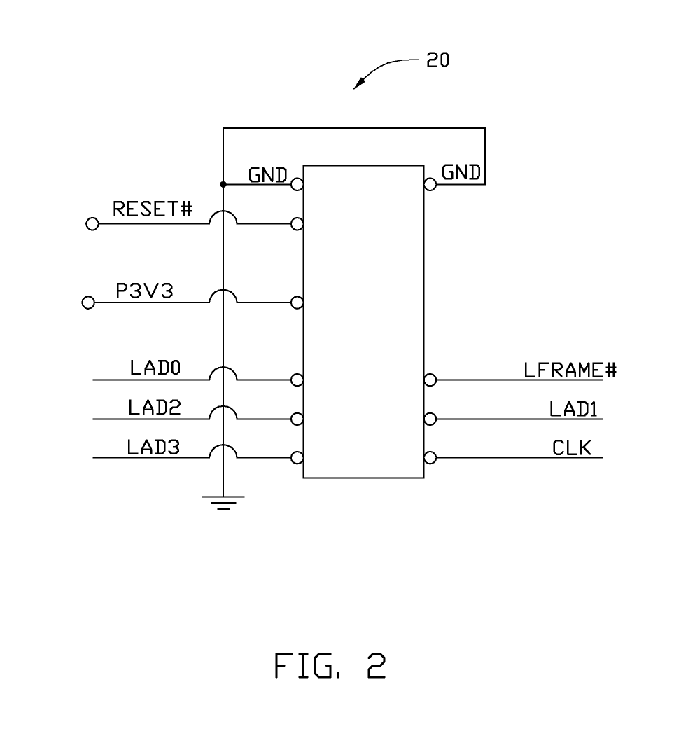

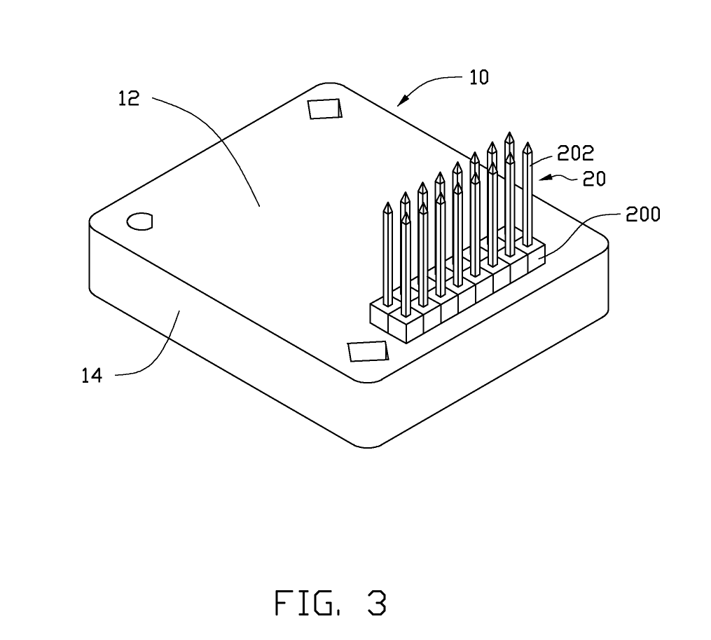

Referring to FIG. 2 and FIG. 3, the connector 20 includes an insulated portion 200 glued on a bottom of the plate 12, and a plurality of pins 202 mounted to the insulated portion 200. First ends of the pins 202 extend through the insulated portion 200 to be electrically connected to the corresponding signal pins 16. Second ends of the pins 202 are exposed through the bottom of the insulated portion 200, which can be connected to a diagnostic card.

The pins 202 includes data pins LAD0˜LAD3, a frame signal pin LFRAME#, a clock signal pin CLK, a reset pin RESET#, a power pin P3V3, and two ground pins GND grounded, all connected to the corresponding signal pins 16. Therefore, after the BIOS chip 30 is accommodated in the receiving space 100, the diagnostic card can communicate with the BIOS chip 30 through the connector 20, to debug the BIOS chip 30.

In use, the apparatus is placed on the motherboard 40, with the receiving space 100 accommodating the BIOS chip 30 and the pins 202 extending up. The diagnostic card is engaged with the connector 20. When the motherboard 40 is powered on, the BIOS chip 30 does a power on self test (POST) and sends the POST codes in hex to an input output (I/O) port 80 of the motherboard 40. Consequently, the diagnostic card can communicate with the BIOS chip 30 by accessing the port 80.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for testing a basic input output system (BIOS) chip, the apparatus comprising:
a base defining a receiving space for housing the BIOS chip, a plurality of signal pins formed on sidewalls bounding the receiving space, to be electrically connected to the BIOS chip; and
a connector extending from a bottom of the base opposite to the receiving space, and electrically connected to the signal pins of the base.

2. The apparatus of claim 1, wherein the connector comprises an insulated portion mounted on the bottom of the base, and a plurality of pins extending through the insulated portion and being coupled to the corresponding signal pins.

3. The apparatus of claim 1, wherein the base comprises a plate, the sidewalls are four sidewalls perpendicularly extending up from sides of the base, the plate and the four sidewalls bound the receiving space, the insulated portion is glued on the bottom of the plate.

4. The apparatus of claim 2, wherein the pins of the connector include includes data pins LAD0˜LAD3, a frame signal pin LFRAME#, a clock signal pin CLK, a reset pin RESET#, a power pin P3V3, and two ground pins GND grounded.
